(19) United States
(12) Patent Application Publication
(10) Pub. No.: US 2019/0043435 A1
(43) Pub. Date: Feb. 7, 2019

(54) ELECTRONIC DEVICE AND METHOD FOR ADJUSTING REFRESH RATE OF DISPLAY SCREEN

(71) Applicants: Fu Tai Hua Industry (Shenzhen) Co., Ltd., Shenzhen (CN); HON HAI PRECISION INDUSTRY CO., LTD., New Taipei (TW)

(72) Inventors: SHUN-CHUAN YANG, New Taipei (TW); LI-MIN YANG, Shenzhen (CN)

(21) Appl. No.: 15/810,248

(22) Filed: Nov. 13, 2017

(30) Foreign Application Priority Data
Aug. 1, 2017 (CN) 201710647092.6

(51) Int. Cl. G09G 3/36; G09G 3/34

(52) U.S. Cl. CPC G09G 3/3618; G09G 2360/16; G09G 2340/16; G09G 3/3406

(57) ABSTRACT

An electronic device includes a display screen, a storage device configured to store a relationship between a display mode of the display screen and a refresh rate of the display screen, and a processor. The processor is configured to detect a current display mode of the display screen, determine the refresh rate corresponding to the current display mode, and adjust the refresh rate of the display screen according to the current display mode.

### CROSS-REFERENCE TO RELATED APPLICATIONS

This application claims priority to Chinese Patent Application No. 201710647092.6 filed on Aug. 1, 2017, the contents of which are incorporated by reference herein.

### FIELD

The subject matter herein generally relates to electronic devices, and more particularly to a method for adjusting a refresh rate of a display screen of an electronic device.

### BACKGROUND

Generally, a refresh rate of a display screen is set and kept the same regardless of the contents displayed on the display screen.

### BRIEF DESCRIPTION OF THE DRAWINGS

Implementations of the present disclosure will now be described, by way of example only, with reference to the attached figures.

FIG. 1 is a diagram of an exemplary embodiment of an electronic device.

FIG. 2 is a diagram of a relationship between a display mode of a display screen and a refresh rate of the display screen.

FIG. 3 is a diagram of the electronic device displaying a plurality of windows.

FIG. 4 is similar to FIG. 3.

FIG. 5 is a flowchart of an exemplary embodiment of a method for adjusting a refresh rate of a display screen of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

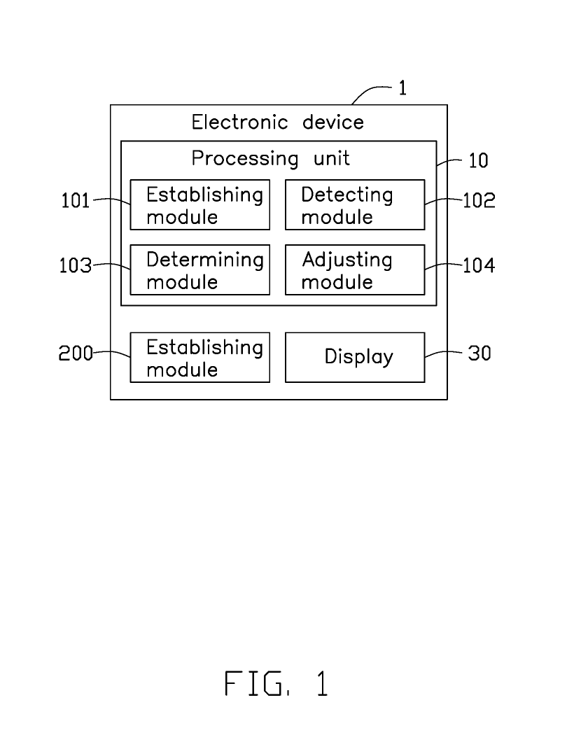

FIG. 1 illustrates an embodiment of an electronic device 1. The electronic device 1 can be a mobile phone, a tablet computer, or the like. The electronic device 1 can include, but is not limited to, a processor 10, a storage device 20, and a display screen 30.

In at least one embodiment, the storage device 20 can be a read-only memory, random access memory, or an external storage device such as a magnetic disk or a hard disk. The storage device 20 can be used to store a relationship between a display mode of the display screen 30 and a refresh rate.

In at least one embodiment, the display screen 30 can be an indium gallium zinc oxide (IGZO) display, which can support a wide range of refresh rates. For example, the refresh rate can be in a range from about 20 Hz to about 120 Hz.

The processor 10 can include an establishing module 101, a detecting module 102, a determining module 103, and an adjusting module 104. The modules 101-104 can include one or more software programs in the form of computerized codes stored in the storage device 20. The computerized codes can include instructions executed by the processor 10 to provide functions for the modules 101-104.

The establishing module 101 can establish the relationship between the display mode of the display screen 30 and the refresh rate and store the relationship in the storage device 20. In at least one embodiment, the relationship can be set by a user.

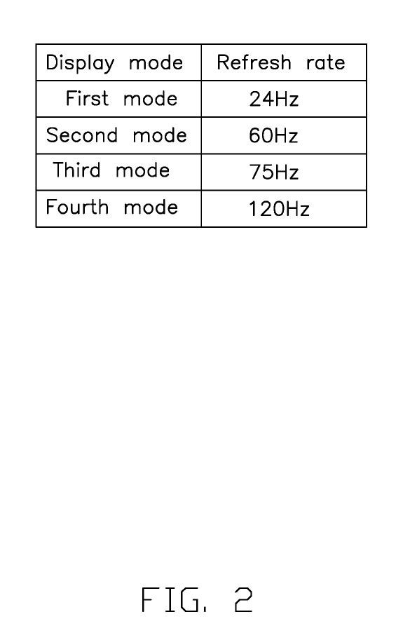

FIG. 2 illustrates the relationship between the display mode and the refresh rate. In at least one embodiment, the display mode can include at least four modes. A first mode is when the display screen 30 display only text. A second mode is when the display screen 30 displays still images with text. A third mode is when the display screen 30 displays moving images, still images, and text. A fourth mode is when the display screen displays a video or other moving graphics. The moving graphics can be a game interface, an animation on a webpage, or the like.

The detecting module 102 can detect a current display mode of the display screen 30. In at least one embodiment, the detecting module 102 can detect the current display mode by detecting contents displayed by the display screen 30. For example, when the detecting module 102 detects that the display screen 30 displays only text, then the detecting module 102 determines that the display mode is in the first mode. When the detecting module 102 detects that the display screen 30 displays still images with text, then the detecting module 102 determines that the display mode is in the second mode. When the detecting module 102 detects that the display screen 30 displays moving images, still images, and text, then the detecting module 102 determines that the display mode is in the third mode. When the detecting module 102 detects that the display screen 30 displays video or other moving graphics, then the detecting module 102 determines that the display mode is in the fourth mode.

The determining module 103 can determine which refresh rate to apply to the display screen 30 according to the current display mode. When the display mode is in the first mode, the determining module 103 can determine the refresh rate to be 24 Hz. When the display mode is in the second mode, the determining module 103 can determine the refresh rate to be 60 Hz. When the display mode is in the third mode, the determining module 103 can determine the refresh rate to be 75 Hz. When the display mode is in the fourth mode, the determining module 103 can determine the refresh rate to be 120 Hz.

The adjusting module 104 can adjust the refresh rate of the display screen 30 according to the refresh rate determined by the determining module 103.

In at least one embodiment, a default refresh rate of the display screen 30 can be 60 Hz. When the first mode is detected, that is, the display screen 30 displays only text which has a lower display requirement, the adjusting module 104 can reduce the refresh rate to correspond to the first mode, so as to save power consumption of the display screen 30. When the third or fourth mode is detected, that is, the display screen 30 displays moving images, still images, and text, or the display screen 30 displays video or other moving graphics, which has a higher display requirement, the adjusting module 104 can increase the refresh rate to correspond to the third or fourth mode, so as to improve picture fluency of the display screen 30. Therefore, a display requirement of the third and fourth mode can be satisfied, and power is not wasted in displaying in the first mode.

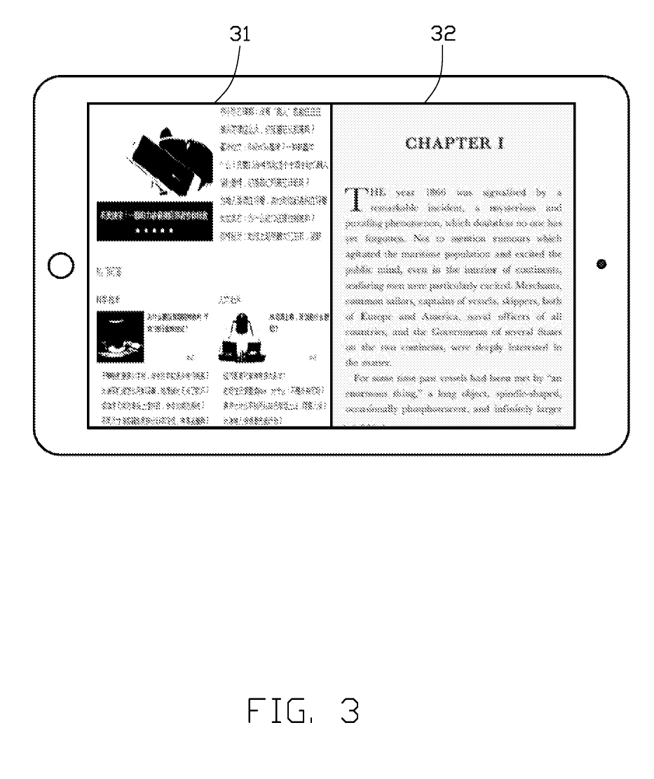

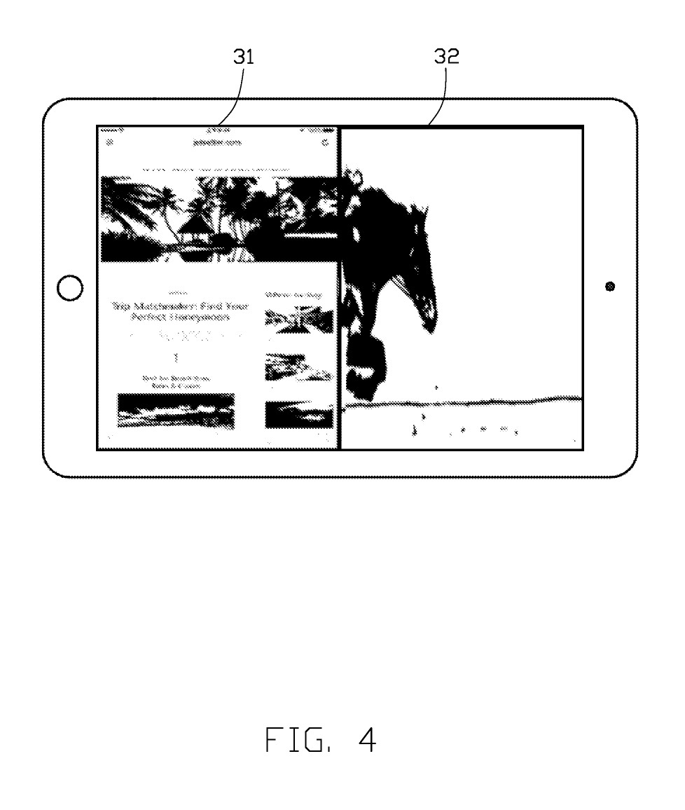

Furthermore, in other embodiment, when the display screen 30 displays multiple windows, the detecting module 102 can detect the display mode of each of the multiple windows, and the determining module 103 can determine which refresh rate to apply to each of the multiple windows according to the detected display mode corresponding to each of the multiple windows. For example, referring to FIGS. 3 and 4, the display screen 30 can display multiple windows, such as a first display window 31 and a second display window 32. As shown in FIG. 3, when the first display window 31 is detected to be in the second mode, the adjusting module 104 does not need to adjust the refresh rate of the first display window 31. When the second display window 32 is detected to be in the first mode, the adjusting module 104 can reduce the refresh rate of the second display window 32 to 24 Hz. As shown in FIG. 4, when the first display window 31 is detected to be in the third mode, the adjusting module 104 can increase the refresh rate of the first display window 31 to 75 Hz. When the second display window 32 is detected to be in the fourth display mode, the adjusting module 104 can increase the refresh rate of the second display window 32 to 120 Hz.

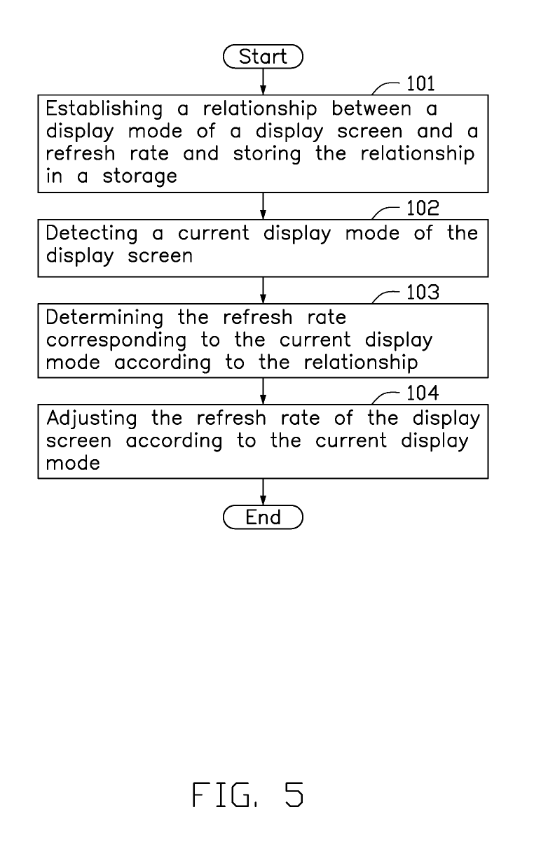

FIG. 5 illustrates a flowchart of an exemplary method for adjusting a refresh rate of a display screen. The example method is provided by way of example, as there are a variety of ways to carry out the method. The method described below can be carried out using the configurations illustrated in FIGS. 1-4, for example, and various elements of these figures are referenced in explaining the example method. Each block shown in FIG. 5 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block S101.

At block S101, a relationship between a display mode of a display screen and a refresh rate of the display screen can be established. The relationship can be stored in a storage of the electronic device.

At block S102, a current display mode of the display screen can be detected. The current display mode can be detected by detecting contents displayed on the display screen.

At block S103, the refresh rate corresponding to the current display mode according to the relationship can be determined.

At block S104, the refresh rate of the display screen can be adjusted according to the current display mode.

Additionally, when the display screen displays a plurality of windows, a refresh rate of each window can be adjusted according to the method described above.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device comprising:
a display screen;
a storage device configured to store a relationship between a display mode of the display screen and a refresh rate of the display screen; and
at least one processor, wherein the storage device stores one or more programs, wherein when executed by the at least one processor, the one or more programs cause the at least one processor to:
detect a current display mode of the display screen;
determine the refresh rate corresponding to the current display mode; and
adjust the refresh rate of the display screen according to the current display mode.

2. The electronic device of claim 1, wherein the at least one processor is further caused to pre-establish the relationship between the display mode and the refresh rate and store the relationship in the storage device.

3. The electronic device of claim 1, wherein the display mode comprises at least one of at least four modes; a first mode is when the display screen displays only text; a second mode is when the display screen displays still images and text; a third mode is when the display screen displays moving images, still images, and text; a fourth mode is when the display screen displays a video or other moving graphics.

4. The electronic device of claim 1, wherein the processor detects the current display mode of the display screen by detecting contents displayed on the display screen.

5. The electronic device of claim 1, wherein the display screen displays a plurality of windows; the processor detects a current display mode of each of the plurality of windows, determines the corresponding refresh rate of each of the plurality of windows, and adjusts the refresh rate of each of the plurality of windows according to the current display mode of each of the plurality of windows.

6. A method for adjusting a refresh rate of a display screen of an electronic device, the method comprising:
detecting a current display mode of the display screen;
determining the refresh rate corresponding to the current display mode according to a relationship between a display mode of the display screen and a refresh rate, wherein the relationship; and
adjusting the refresh rate of the display screen according to the current display mode.

7. The method of claim 6, further comprising pre-establishing the relationship between the display mode and the refresh rate of the display screen and storing the relationship in the electronic device.

8. The method of claim 6, wherein the display mode comprises at least one of at least four modes; a first mode is when the display screen displays only text; a second mode is when the display screen displays still images and text; a third mode is when the display screen displays moving images, still images, and text; a fourth mode is when the display screen displays a video or other moving graphics.

9. The method of claim 6, wherein detecting the current display mode of the display screen is by detecting contents displayed on the display screen.

10. The method of claim 6, further comprising detecting a current display mode of each of a plurality of windows displayed on the display screen, determining the corresponding refresh rate of each of the plurality of windows, and adjusting the refresh rate of each of the plurality of windows according to the current display mode of each of the plurality of windows.

11. A non-transitory storage medium having stored thereon instructions that, when executed by a processor of an electronic device, causes the processor to perform a method for adjusting a refresh rate of a display screen of the electronic device, wherein the method comprises:
detecting a current display mode of the display screen;
determining the refresh rate corresponding to the current display mode according to a relationship between a display mode of the display screen and a refresh rate, wherein the relationship; and
adjusting the refresh rate of the display screen according to the current display mode.

12. The non-transitory storage medium of claim 11, further comprising pre-establishing the relationship between the display mode and the refresh rate of the display screen and storing the relationship in the storage medium.

13. The non-transitory storage medium of claim 11, wherein the display mode comprises at least one of at least four modes; a first mode is when the display screen displays only text; a second mode is when the display screen displays still images and text; a third mode is when the display screen displays moving images, still images, and text; a fourth mode is when the display screen displays a video or other moving graphics.

14. The non-transitory storage medium of claim 11, wherein the processor detects the current display mode of the display screen by detecting contents displayed on the display screen.

15. The non-transitory storage medium of claim 11, wherein the display screen displays a plurality of windows; the processor detects a current display mode of each of the plurality of windows, determines the corresponding refresh rate of each of the plurality of windows, and adjusts the refresh rate of each of the plurality of windows according to the current display mode.
